(19) United States
(12) Patent Application Publication
(10) Pub. No.: US 2006/0162654 A1
(43) Pub. Date: Jul. 27, 2006

(54) Spray shield and methods of using the same

(76) Inventor: Kenneth Greenway, Pukalani, HI (US)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 11/041,508

(22) Filed: Jan. 21, 2005

(51) Int. Cl. B05C 11/11; E04B 2/00; E04B 9/00; E06B 9/00

(52) U.S. Cl. 118/504; 118/505; 160/368.1; 52/506.01; 52/506.05

(57) ABSTRACT

The disclosure relates to a reusable spray shield that can be used in painting applications such as the painting of residential and commercial buildings to protect an object that is not to be painted from paint overspray or errant paint particles. The reusable spray shield includes a frame and a membrane. The membrane can be a flexible plastic sheet that is attached to the frame with a number of attachment devices, such as VELCRO® pads bonded to both the membrane and the frame. The membrane can be quickly removed and replaced. The used membrane can be disposed of with the paint supplies according to local disposal guidelines. In addition, the frame can be quickly put together and taken apart. The frame, in its component parts, permits the frame to be easily transported from one location to the next.

### BACKGROUND OF THE INVENTION

1. Field of the Invention

This disclosure relates to a spray shield for use in painting applications, in particular, the painting of residential and commercial buildings.

2. Description of the Related Art

Spray painting, painting with a brush, or painting with a roller are some common ways to apply paint. One priority with any of these application techniques is to keep stray or errant paint particles from landing on nearby objects that are not intended to be painted.

In one example, painting a wooden deck that is surrounded by flora can pose difficulties for painters. When attempting to paint the balusters of the wooden railing, the painter must be careful to not allow paint particles to land on the surrounding flora. A common method for protecting flora is to cover it with large tarps or canvas sheets. Over time, however, accumulated paint on the tarps makes them heavy and stiff. In addition, tarps that are wet with paint are difficult to move and are prone to create even more of a mess unless the painter waits until the tarp dries.

Painters typically must have about 10-20 tarps available for a typical job. The tarps take up critical space in the painter's work vehicle, the dried paint on the tarps chips and peels off when the tarps are opened at the next job site, and the tarps must be continually unloaded, unfolded, refolded, and reloaded into the work vehicle at each job site.

### SUMMARY OF THE INVENTION

The disclosure herein provides for an easy to assemble/disassemble and maneuverable spray shield for painting applications. The spray shield includes a lightweight, spray shield frame and a flexible membrane. The membrane is easily attachable and detachable from the frame and the membrane can be reused or discarded. The spray shield frame includes quick connect/disconnect features so that the frame can be quickly assembled and disassembled at a job site.

In one aspect, a reusable spray shield includes a frame having a plurality of frame members to include at least a first member and a second member detachably coupled by at least one transverse member, the at least one transverse member configured to maintain the first and second members spaced apart from each other; a membrane sized and shaped to extend from the first member to the second member; and attachment means for removably attaching the membrane to a first side of the frame.

In another aspect, a method of using a reusable spray shield to protect an object from overspray includes assembling a plurality of frame members to form a spray shield frame; attaching a membrane onto the spray shield frame to form the spray shield; holding the spray shield in a first position to substantially prevent paint particles from contacting the object that is being shielded; detaching the membrane from the spray shield frame, and disassembling the frame members.

### BRIEF DESCRIPTION OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements may be enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a front, right isometric view of a spray shield according to one illustrated embodiment of the invention.

FIG. 2 is an exploded, isometric view of the spray shield of FIG. 1.

FIG. 3 is a front, right isometric view of a spray shield having only one transverse member according to another illustrated embodiment of the invention.

FIG. 4 is an exploded, isometric, partial view of the spray shield of FIG. 1 showing one method of assembling the spray shield frame members according to one illustrated embodiment of the invention.

FIG. 5 is an exploded, cross sectional view of a frame member receiving an insert and a bolt according to one illustrated embodiment of the invention.

FIG. 6 is a front right isometric, partial view of the completed assembly of two frame members of a spray shield according to one illustrated embodiment of the invention.

FIG. 7 is a front right isometric view of the spray shield of FIG. 1 being used to intercept paint particles and shield an object during a deck painting operation.

### DETAILED DESCRIPTION OF THE INVENTION

In the following description, certain specific details are set forth in order to provide a thorough understanding of various embodiments of the invention. One skilled in the art will understand that the invention may be practiced without all of these details. In other instances, well-known structures associated with painting systems, painting materials, and various types of tooling used in painting applications have not been shown or described in detail to avoid unnecessarily obscuring descriptions of the embodiments of the invention.

Unless the context requires otherwise, throughout the specification and claims which follow, the word “comprise” and variations thereof, such as, “comprises” and “comprising” are to be construed in an open, inclusive sense, that is as “including, but not limited to.”

The headings provided herein are for convenience only and do not affect the scope or meaning of the claimed invention.

Reusable Spray Shield

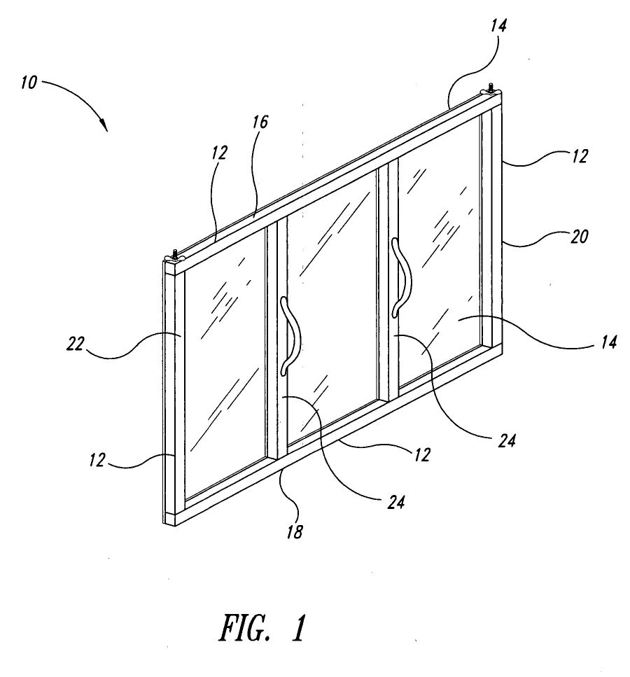

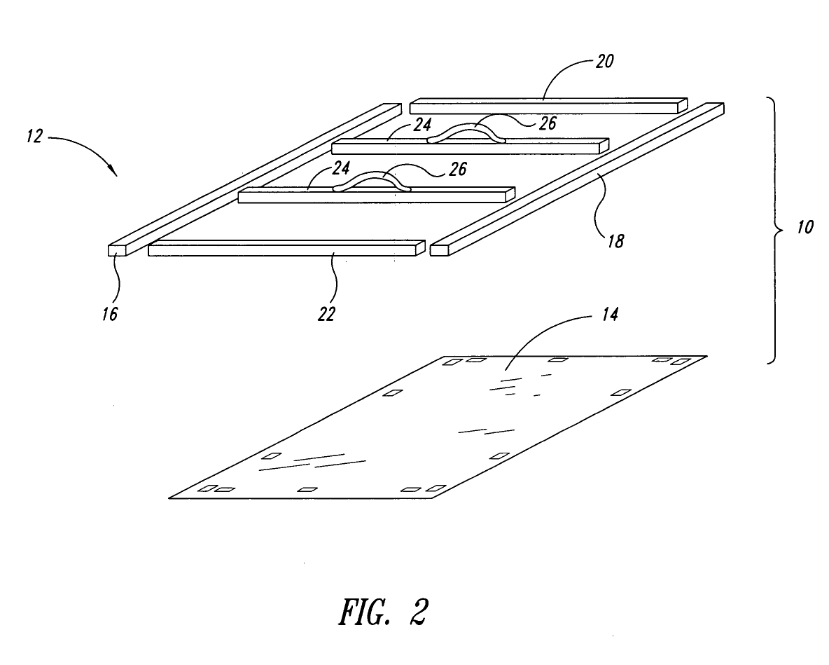

FIGS. 1 and 2 show a spray shield 10 according to one illustrated embodiment of the present invention. The spray shield 10 is comprised of a frame 12 and a membrane 14. The illustrated frame 12 includes two laterally oriented frame members 16, 18 and two vertically oriented frame members 20, 22. The described orientations are provided in relation to the respective figures; however, it is understood that the orientations of the various components of the spray shield 10 will vary during usage, storage, and transit. In addition, the frame 12 can include at least one intermediate member 24. Two intermediate members 24 are shown in the illustrated embodiment. Handles 26 are attached to the illustrated intermediate members 24 for manipulating and transporting the spray shield 10.

The frame 12 can be made from wood, plastic, foam, a composite material such as fiberglass, or some other suitable material. In the illustrated embodiment, the shape of the frame 12 is rectangular. One skilled in the art will appreciate and understand, however, that the frame may have rounded corners, may be square, or may be shaped in a variety of ways depending on the specific type of painting application.

The membrane 14 of the spray shield 10 is attachable to and detachable from the frame 12. The membrane 14 can be made from a plastic sheet, synthetic or non-synthetic fabric material, or some equivalent substance that is capable of receiving paint spray. In one embodiment, the membrane 14 is made from an absorbent material such as canvas. One skilled in the art will appreciate and understand that the amount of flexibility in the membrane 14 can be altered by the user depending on a particular painting application or depending on certain conditions. For example, a thin-walled plastic panel covered with a thin layer of canvas could be used during windy conditions in which the added stiffness of the plastic panel would reinforce the canvas.

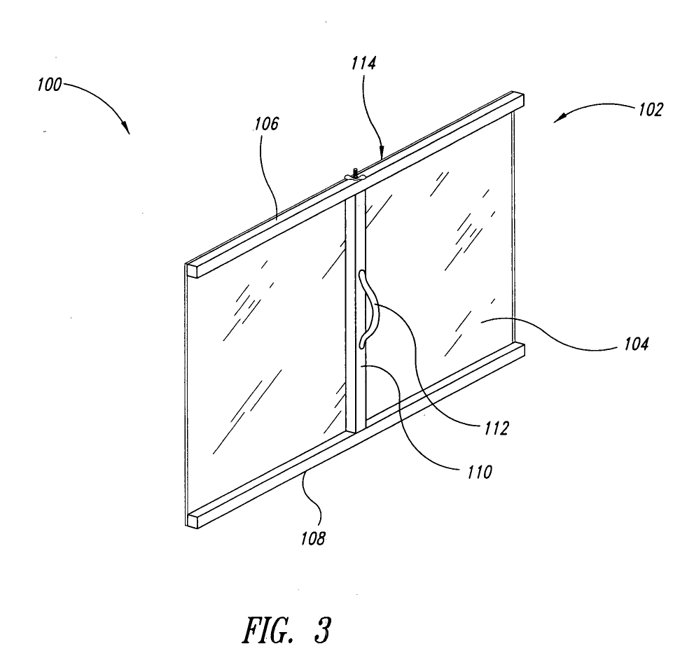

FIG. 3 illustrates a spray shield 100 according to an alternate embodiment of the present invention. The spray shield 100 is comprised of a frame 102 and a membrane 104. The illustrated frame 102 includes two frame members 106, 108 connected by a transverse frame member 110. The frame 102 can be assembled and disassembled as described below. Again, it is understood that the orientation of the frame 102 may vary during usage, storage, and transit. A handle 112 is attached to the transverse member 110 for manipulating and transporting the spray shield 100 in the illustrated embodiment. In an alternate embodiment, a handle 112 (or handles) can be attached to the frame members 106, 108. The membrane 104 is removably attachable to a first side 114 of the frame 102. In addition, the membrane 104 is sized and shaped to extend from the one frame member 106 to the other frame member 108 and also extend substantially along the length of the frame members 106, 108.

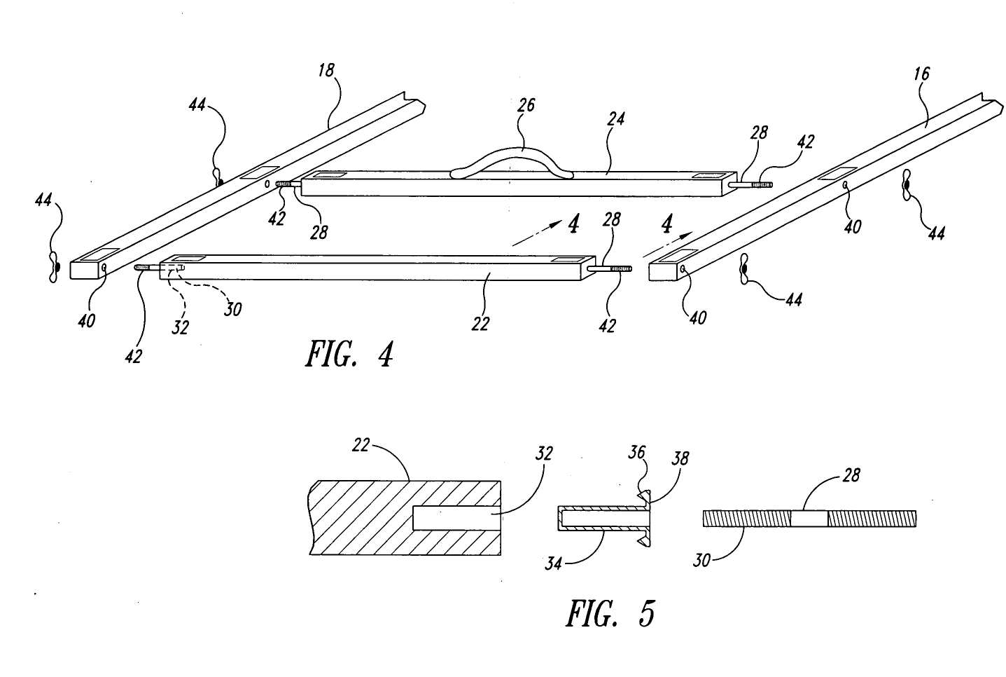

FIGS. 4-6 illustrate particular methods of assembling a spray shield, with reference being made to the embodiment of the spray shield 10 illustrated in FIG. 1. One skilled in the art will appreciate that the described methods are applicable to any of the spray shield embodiments described herein or formed from the teachings provided herein. For each of the methods, the ends of the two vertically oriented frame members 20, 22 and the ends of the intermediate frame members 24 are provided with bolts 28. A first end 30 of the bolt 28 is recessed into an opening 32 located in the end of the respective frame member 20, 22, 24.

As illustrated in FIG. 4, the bolts 28 can be secured in the openings 32 by being mechanically fastened or bonded. Additionally or alternatively, FIG. 5 shows an insert 34 pressed into the opening 32. The insert 34 can provide a more robust and durable connection. Anti-rotation tabs 36 positioned on a head 38 of the insert 34 are used to penetrate the end of the frame member 22. These anti-rotation tabs 36 prevent the insert 34 from torquing-out when the bolt 28 is inserted. One advantage of using inserts 34 is that damage to an insert 34 would not necessarily require replacement of the entire frame member 22. The damaged insert 34 could be removed and replaced with a new insert provided that there was sufficient material integrity at the end of the frame member 22 to receive the replacement anti-rotation tabs 36.

Referring back to FIG. 4, the two laterally oriented frame members 16, 18 include through openings 40 for receiving a second end 42 of the bolts 28. The second end 42 of the bolts 28 can be secured with a nut 44, for example a wing nuts as shown in the illustrated embodiment. Although not shown in the illustrated embodiment, lock washers can be provided under the nuts 44. The nuts 44 can be sufficiently tightened by hand without a need for a wrench or other tools. One advantage of using wing nuts 44 is that no tools are needed, which decreases the time required to assemble and disassemble the spray shield 10.

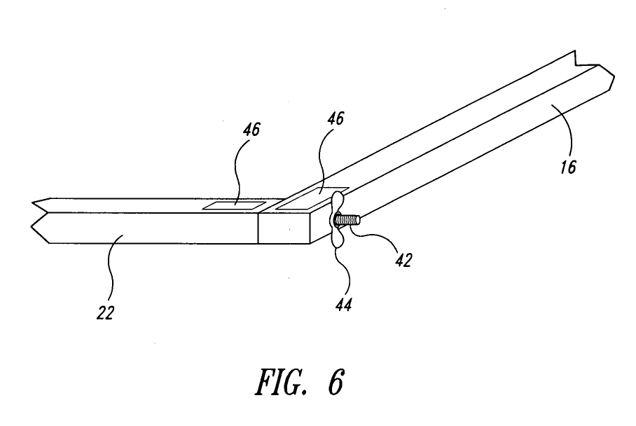

FIG. 6 shows an assembled joint of the spray shield 10 with the attachment means for attaching the membrane 14 with the frame 12. In the illustrated embodiment, the attachment means 46 are VELCRO® pads 46 adhered onto the frame members 16, 18, 20, 22, 24, at desired locations. The membrane 14 includes VELCRO® pads positioned thereon to interact with the pads 46 located on the frame members 12. VELCRO® is a hook and loop fastening system and the name is derived from Velour Crochet, which is the French phrase for velvet hook. One skilled in the art will appreciate and understand that the “hook” style pads can be placed on either the frame members 12 or the membrane 14 while the complementary “loop” style pads are placed on the other respective frame members 12 or membrane 14.

In another embodiment, the membrane 14 is attached to the frame members 12 with a water-soluble adhesive. At the end of a painting job, the spray shield 10 can be sprayed with water to release the membrane 14 from the frame members 12.

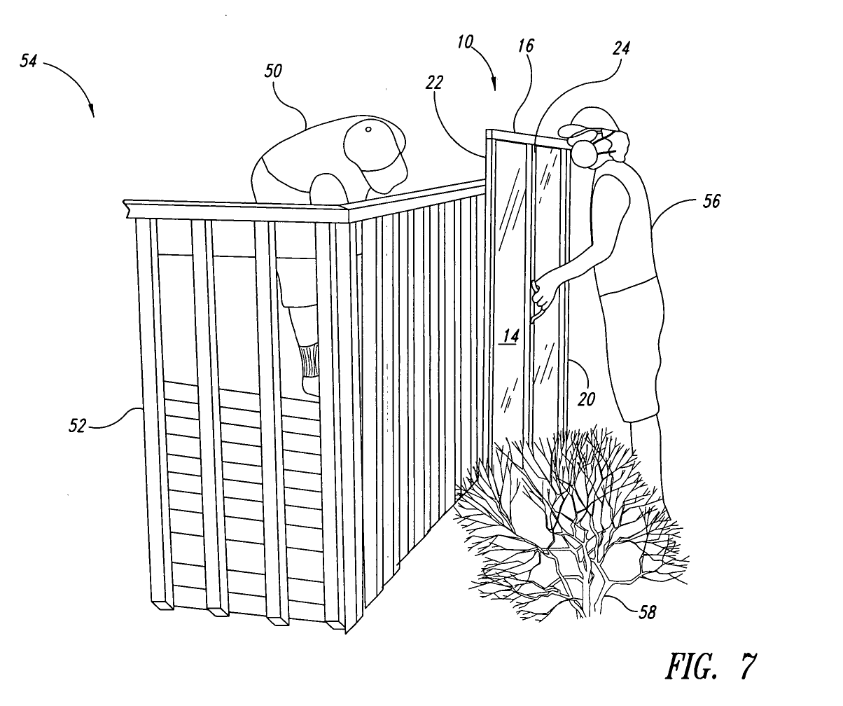

FIG. 7 shows a spray shield 10 having one intermediate member 24 and one respective handle 26 in use during a painting application. As one painter 50 applies paint to the balusters 52 of a wooden deck 54, another painter 56 maneuvers and positions the spray shield 10 to prevent any paint particles from contacting and thus discoloring the shrubbery 58 adjacent to the deck 54. The reference to the shrubbery 58 is used for exemplary purposes only and one skilled in the art will understand and appreciate that the spray shield 10 can be used to a variety of ways to protect a variety of different objects from paint particles and paint overspray.

One advantage of the spray shield 10 is that different size shields 10 can be made for different painting applications. Smaller spray shields 10, for example, can be used for confined or tight spaces. Larger spray shields 10 can be used for larger jobs such as painting a wooden deck as described above.

Another advantage of the spray shield 10 is that the overall weight of the spray shield 10 may actually be less than a conventional canvas tarp, especially after the tarp has been covered with paint from a number of painting jobs. The low weight of the spray shield 10 permits the painter holding the spray shield 10 to easily maneuver and hold the spray shield 10.

The various embodiments described above can be combined to provide further embodiments. Any U.S. patents, patent applications and publications referred to in this specification are incorporated herein by reference. Aspects of the invention can be modified, if necessary, to employ devices, features, and concepts of the various patents, applications and publications to provide yet further embodiments of the invention.

These and other changes can be made to the invention in light of the above detailed description. In general, in the following claims, the terms used should not be construed to limit the invention to the specific embodiments disclosed in the specification and the claims, but should be construed to include all devices and systems for shielding objects from paint particles and/or paint overspray that operate in accordance with the claims. Accordingly, the invention is not limited by the disclosure, but instead its scope is to be determined entirely by the following claims.

What is claimed is:

1. A reusable spray shield, the spray shield comprising:
a frame having a plurality of frame members to include at least a first member and a second member detachably coupled by at least one transverse member, the at least one transverse member configured to maintain the first and second members spaced apart from each other;
a membrane sized and shaped to extend from the first member to the second member; and
attachment means for removably attaching the membrane to a first side of the frame.

2. The reusable spray shield of claim 1 wherein the first member, the second member, and the at least one transverse member are made from wood.

3. The reusable spray shield of claim 1 wherein the first member, the second member, and the at least one transverse member are made from plastic.

4. The reusable spray shield of claim 1, further comprising:
a second transverse member detachably coupled with the first and second members.

5. The reusable spray shield of claim 4 wherein the frame is assembled with bolts and wing nuts.

6. The reusable spray shield of claim 5 wherein the bolts are fixed into an opening in at least some of the frame members.

7. The reusable spray shield of claim 1 wherein a first edge of the at least one transverse member is substantially coplanar with a first edge of the first and second members.

8. The reusable spray shield of claim 1 wherein a perimeter shape of the membrane is rectangular.

9. The reusable spray shield of claim 1 wherein the membrane is a flexible fabric.

10. The reusable spray shield of claim 1 wherein the membrane is a plastic film.

11. The reusable spray shield of claim 1 wherein the membrane has an average thickness in the range of about 0.0005 to 0.005 inches.

12. The reusable spray shield of claim 1 wherein the attachment means for removably attaching the membrane to the frame is comprised of a plurality of VELCRO® pads, a first set of pads attached to an edge surface of the frame, a second set of pads attached to the membrane in complementary locations relative to the first set of pads.

13. The reusable spray shield of claim 1 wherein the attachment means for removably attaching the membrane to the frame is a bonding agent.

14. The reusable spray shield of claim 1, further comprising:
a handle attached to a second side of the frame, the second side opposing the first side onto which the membrane is attached.

15. A method of using a reusable spray shield to protect an object from overspray, the method comprising:
assembling a plurality of frame members to form a spray shield frame;
attaching a membrane onto the spray shield frame to form the spray shield;
holding the spray shield in a first position to substantially prevent paint particles from contacting the object that is being shielded;
detaching the membrane from the spray shield frame; and
disassembling the frame members.

16. The method of claim 15 wherein attaching the membrane onto the spray shield frame includes aligning VELCRO® pads located on the membrane with complementarily positioned VELCRO® pads located on the spray shield frame.

17. The method of claim 15 wherein holding the spray shield in a first position includes holding at least one handle mounted to the spray shield frame.

18. The method of claim 15, further comprising:
discarding the detached membrane.
